(19) United States
(12) Patent Application Publication
(10) Pub. No.: US 2007/0258675 A1
(43) Pub. Date: Nov. 8, 2007

(54) Multiplexed optical communication between chips on a multi-chip module

(75) Inventors: Jonathan Gorrell, Gainesville, FL (US); Mark Davidson, Florahome, FL (US); Henry Davis, Ash Fork, AZ (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,126

(22) Filed: May 5, 2006

(51) Int. Cl. G02B 6/12; G02B 6/00

(52) U.S. Cl. 385/14; 385/15; 385/88; 385/122

(57) ABSTRACT

When using micro-resonant structures, it is possible to use the same source of charged particles to cause multiple resonant structures to emit electromagnetic radiation. This reduces the number of sources that are required for multi-element configurations, such as displays with plural rows (or columns) of pixels. In one such embodiment, at least one deflector is placed in between first and second resonant structures. After the beam passes by at least a portion of the first resonant structure, it is directed to a path such that it can be directed towards the second resonant structure. The amount of deflection needed to direct the beam toward the second resonant structure is based on the amount of deflection, if any, that the beam underwent as it passed by the first resonant structure. This process can be repeated in series as necessary to produce a set of resonant structures in series.

### CROSS-REFERENCE TO CO-PENDING RELATED APPLICATIONS

The present invention is related to the following co-pending U.S. patent applications which are all commonly owned with the present application at the time of this filing, the entire contents of each of which are incorporated herein by reference:
(1) U.S. patent application Ser. No. 11/302,471, entitled “Coupled Nano-Resonating Energy Emitting Structures,” filed Dec. 14, 2005 (attached hereto as Appendix 1);
(2) U.S. patent application Ser. No. 11/349,963, entitled “Method and Structure For Coupling Two Microcircuits,” filed Feb. 9, 2006 (attached hereto as Appendix 2);
(3) U.S. patent application Ser. No. 11/238,991, filed Sep. 30, 2005, entitled “Ultra-Small Resonating Charged Particle Beam Modulator” (attached hereto as Appendix 3);
(4) U.S. patent application Ser. No. 10/917,511, filed on Aug. 13, 2004, entitled “Patterning Thin Metal Film by Dry Reactive Ion Etching” (published as US 2006-0035173 A1 on Feb. 16, 2006);
(5) U.S. application Ser. No. 11/203,407, filed on Aug. 15, 2005, entitled “Method Of Patterning Ultra-Small Structures” (attached hereto as Appendix 5);
(6) U.S. application Ser. No. 11/243,476, filed on Oct. 5, 2005, entitled “Structures And Methods For Coupling Energy From An Electromagnetic Wave” (attached hereto as Appendix 6);
(7) U.S. application Ser. No. 11/243,477, filed on Oct. 5, 2005, entitled “Electron beam induced resonance, (attached hereto as Appendix 7)”
(8) U.S. application Ser. No. 11/325,448, entitled “Selectable Frequency Light Emitter from Single Metal Layer,” filed Jan. 5, 2006 (attached hereto as Appendix 8);
(9) U.S. application Ser. No. 11/325,432, entitled, “Matrix Array Display,” filed Jan. 5, 2006 (attached hereto as Appendix 9);
(10) U.S. application Ser. No. 11/410,905, entitled, “Coupling Light of Light Emitting Resonator to Waveguide,” and filed Apr. 26, 2006 (attached hereto as Appendix 10);
(11) U.S. application Ser. No. 11/411,120, entitled “Free Space Interchip Communication,” and filed on Apr. 26, 2006 (attached hereto as Appendix 11);
(12) U.S. application Ser. No. 11/410,924, entitled, “Selectable Frequency EMR Emitter,” filed Apr. 26, 2006 (attached hereto as Appendix 12);
(13) U.S. patent application Ser. No. 11/400,280, entitled “Resonant Detector for Optical Signals,” filed Apr. 10, 2006 (attached hereto as Appendix 13);
(14) U.S. application Ser. No. 11/353,208, entitled “Electron Beam Induced Resonance,” filed Feb. 14, 2006 (attached hereto as Appendix 14);
(15) U.S. application Ser. No. 11/325,571, entitled “Switching Micro-Resonant Structures By Modulating A Beam Of Charged Particles,” filed Jan. 5, 2006 (attached hereto as Appendix 15);
(16) U.S. application Ser. No. 11/350,812, entitled “Conductive Polymers For The Electroplating,” filed Feb. 10, 2006 (attached hereto as Appendix 4);
(17) U.S. application Ser. No. 11/325,534, entitled “Switching Micro-Resonant Structures Using At Least One Director,” filed Jan. 5, 2006 (attached hereto as Appendix 17); and
(18) U.S. Application No. 60/777,120, entitled “Systems And Methods Of Utilizing Resonant Structures,” filed Feb. 28, 2006 (attached hereto as Appendix 18).

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to electromagnetic radiation devices, and, more particularly, to coupling output from light-emitting structures.

### INTRODUCTION

A so-called multi-chip module (“MCM”) is generally considered to be an integrated circuit package that contains two or more interconnected chips.

It is desirable to use EMR to communicate between chips in a multi-chip module. It is still further desirable to reduce interconnect requirements between chips in a multi-chip module.

### BRIEF DESCRIPTION OF THE DRAWINGS

The following description, given with respect to the attached drawings, may be better understood with reference to the non-limiting examples of the drawings, wherein:

FIGS. 1-3 show structures for coupling emitted light;

FIG. 4 depicts the logical structure of a multi-chip module;

FIG. 5 shows the logical circuitry within a chip;

FIG. 6 is a side-view of a set of optically interconnected integrated circuits; and

FIG. 7 shows the use of an optical connector.

### THE PRESENTLY PREFERRED EXEMPLARY EMBODIMENTS

Various exemplary EMR-emitting micro-resonant structures have been described in the related applications. For example, U.S. application Ser. No. 11/410,924, entitled, “Selectable Frequency EMR Emitter,” (described in greater detail above and attached hereto as Appendix 12) describes various exemplary light-emitting micro-resonant structures. The structures disclosed therein can emit light (such as infrared light, visible light or ultraviolet light or any other electromagnetic radiation (EMR) at a wide range of frequencies, and often at a frequency higher than that of microwave). The EMR is emitted when the resonant structure is exposed to a beam of charged particles ejected from or emitted by a source of charged particles. The source may be controlled by applying a signal on data input. The source can be any desired source of charged particles such as an ion gun, a thermionic filament, a tungsten filament, a cathode, a field-emission cathode, a planar vacuum triode, an electron-impact ionizer, a laser ionizer, a chemical ionizer, a thermal ionizer, an ion-impact ionizer, an electron gun, an ion source, an electron source from a scanning electron microscope, etc.

It is sometimes desirable to couple the emitted light so as to direct it to some other location. For example, a communications medium (e.g., a fiber optic cable) may be provided in close proximity to the resonant structures such that light emitted from the resonant structures is directed in the direction of a receiver, as is illustrated, e.g., in FIG. 21 of U.S. application Ser. No. 11/410,924 (attached hereto as Appendix 12).

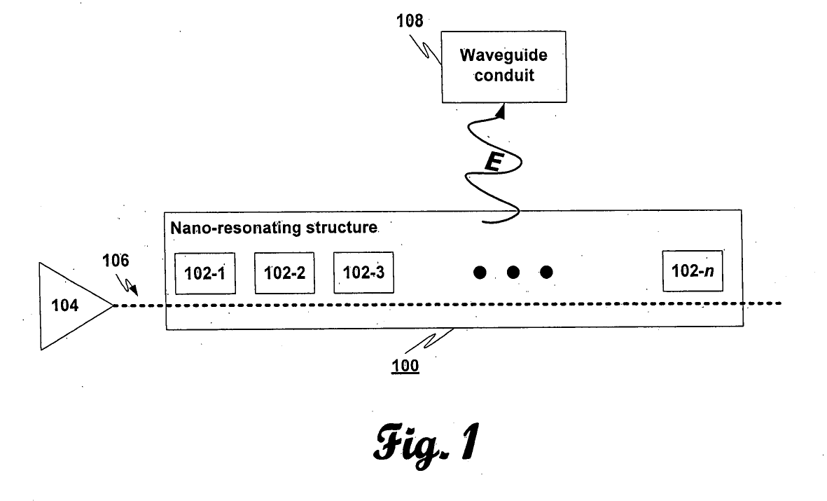

FIG. 1 shows a typical-light-emitting device 200 according to embodiments of the present invention. The device 200 includes at least one element 202 formed on a substrate 204 (such as a semiconductor substrate or a circuit board). The element 202 is made up of at least one resonant structure that emits light (such as infrared light, visible light or ultraviolet light or any other electromagnetic radiation (EMR) 206 at a wide range of frequencies, and often at a frequency higher than that of microwave). The EMR 206 is emitted when the resonant structure is exposed to a beam 208 of charged particles ejected from or emitted by a source of charged particles 210. The charged particle beam can include ions (positive or negative), electrons, protons and the like. The beam may be produced by any source, including, e.g., without limitation an ion gun, a tungsten filament, a cathode, a planar vacuum triode, an electron-impact ionizer, a laser ionizer, a chemical ionizer, a thermal ionizer, an ion-impact ionizer.

The devices described produce electromagnetic radiation by the excitation of ultra-small resonant structures. The resonant excitation in such a device is induced by electromagnetic interaction which is caused, e.g., by the passing of a charged particle beam in close proximity to the device.

Such a device as represented in FIG. 1 may be made, e.g., using techniques such as described in U.S. patent application Ser. No. 10/917,511, entitled “Patterning Thin Metal Film by Dry Reactive Ion Etching” and/or U.S. application Ser. No. 11/203,407, entitled “Method Of Patterning Ultra-Small Structures,” both of which have been incorporated herein by reference (and both of which are attached hereto as appendices 4 and 5, respectively). The element 202 may comprise any number of resonant microstructures constructed and adapted to produce EMR, e.g., as described above and/or in U.S. application Ser. No. 11/325,448, entitled “Selectable Frequency Light Emitter from Single Metal Layer,” filed Jan. 5, 2006, U.S. application Ser. No. 11/325,432, entitled, “Matrix Array Display,” filed Jan. 5, 2006, and U.S. application Ser. No. 11/243,476, filed on Oct. 5, 2005, entitled “Structures And Methods For Coupling Energy From An Electromagnetic Wave”; U.S. application Ser. No. 11/243,477, filed on Oct. 5, 2005, entitled “Electron beam induced resonance;” and U.S. application Ser. No. 11/302,471, entitled “Coupled Nano-Resonating Energy Emitting Structures,” filed Dec. 14, 2005 (attached hereto as appendices 8, 9, 6, 7, and 1, respectively).

The electromagnetic radiation produced by the nano-resonating structure 202 may be coupled to an electromagnetic wave via a waveguide conduit 212 positioned in the proximity of nano-resonating structure 202. The waveguide conduit may be, for example, an optical fiber or the like or any structure described in related U.S. application Ser. No. 11/410,905 (described in greater detail above).

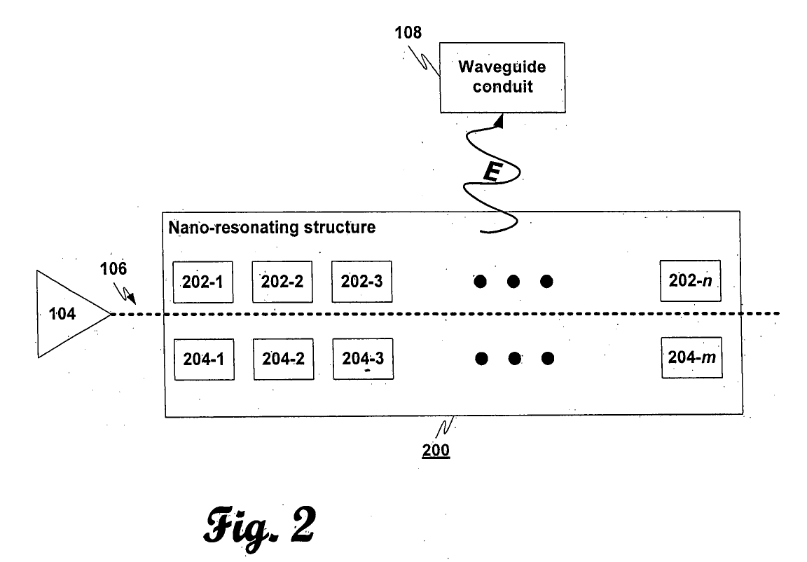

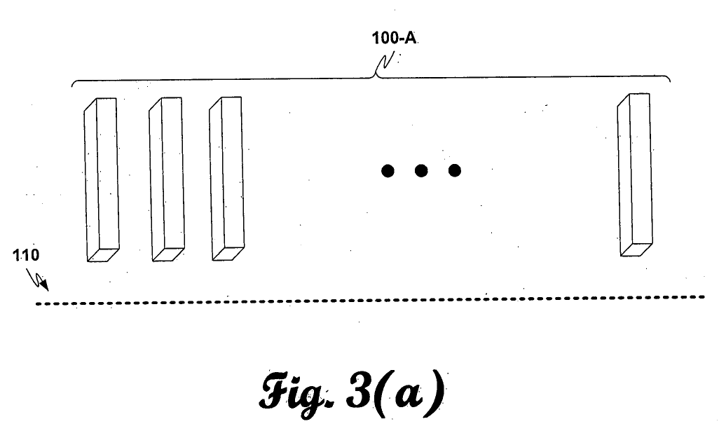

The actual positioning of a particular waveguide conduit will depend, at least in part, on the form and type of the particular nano-resonating structure 202. Different structures will emit light at different angles relative to the surface of the substrate 204, and relative to the various components of the structure 202. In general, as shown, e.g., in FIG. 2, light is emitted in a conical volume 214, and the waveguide conduit 212 should be positioned within that volume, preferably centered within that volume.

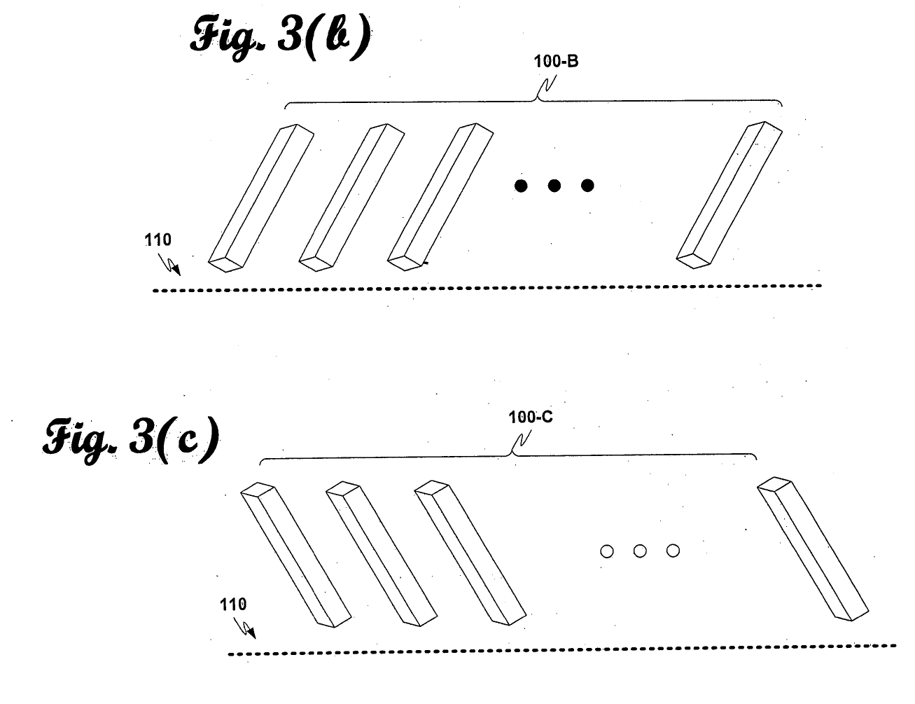

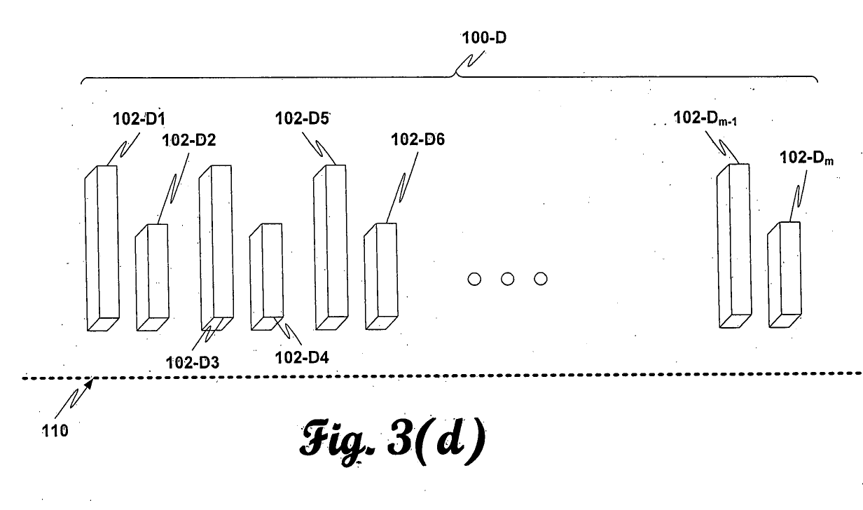

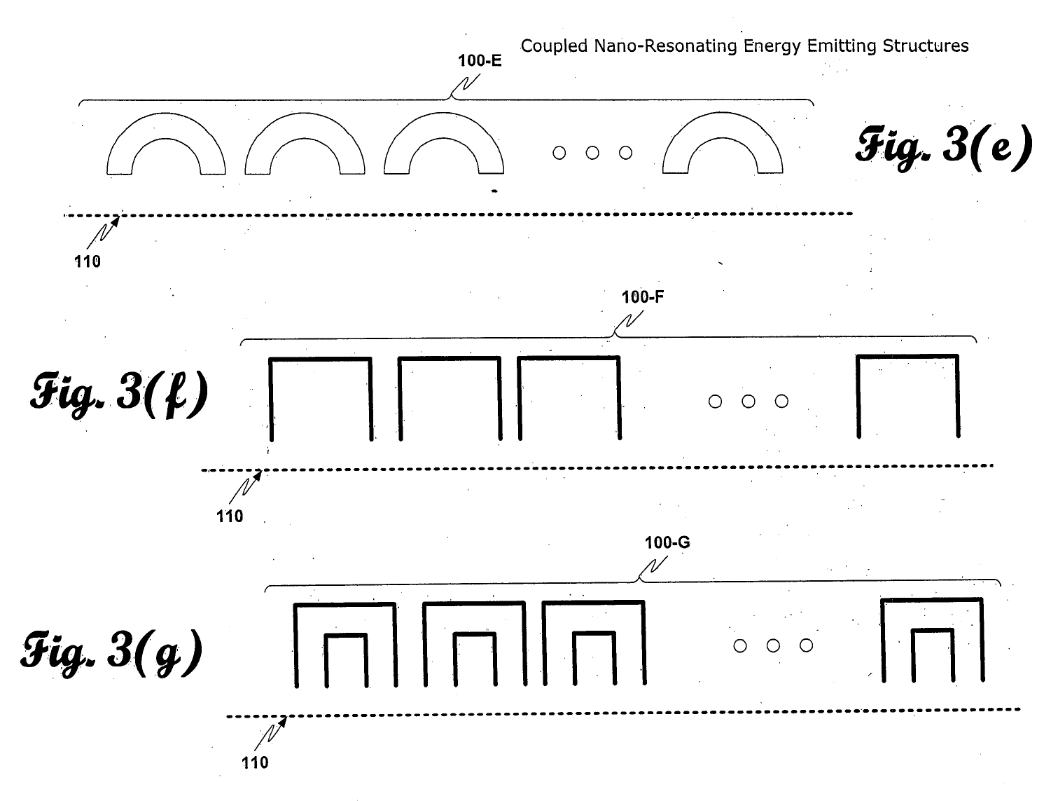

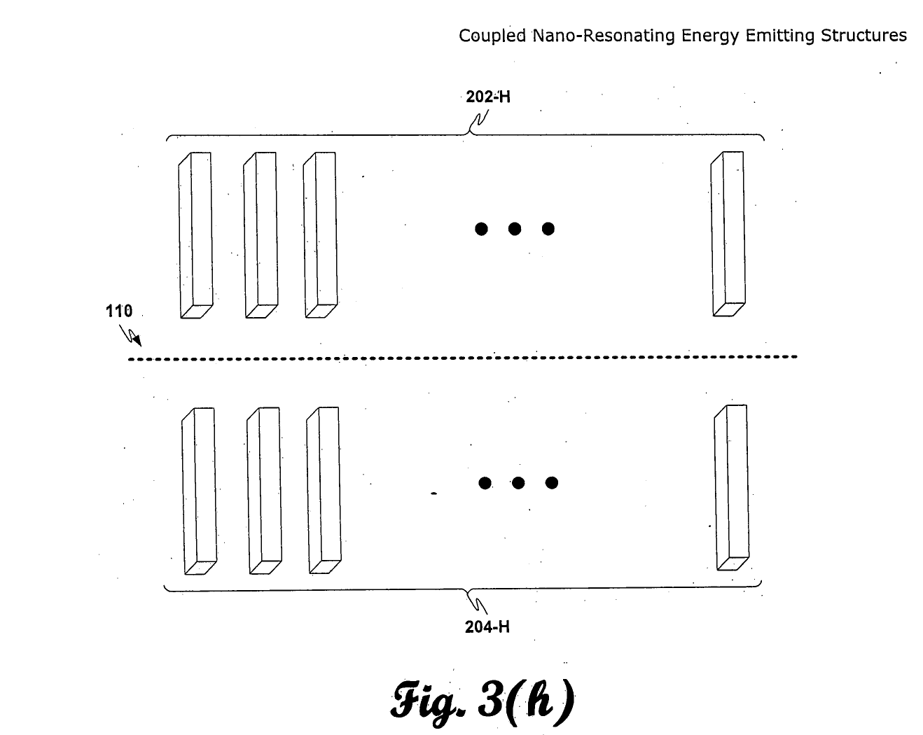

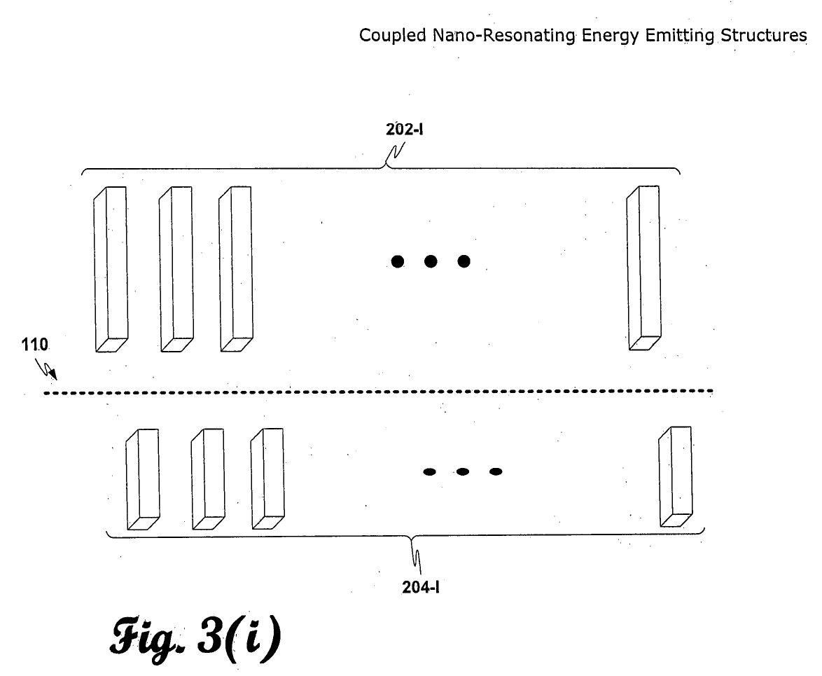

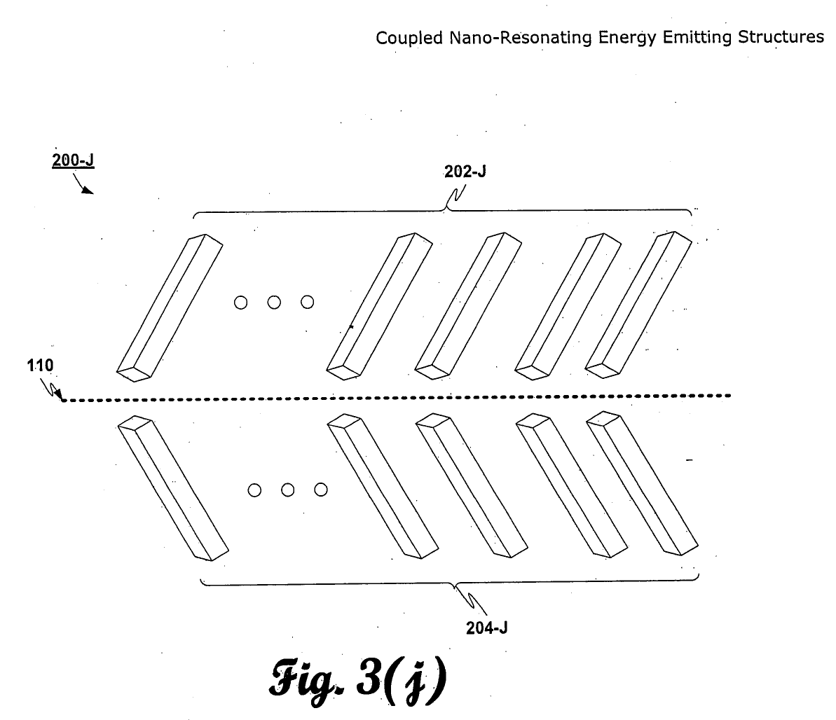

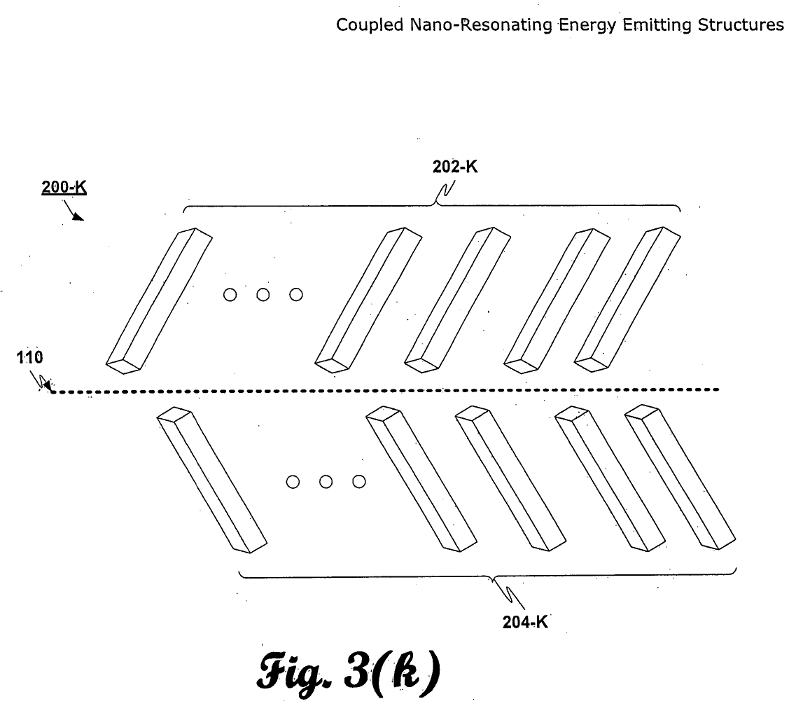

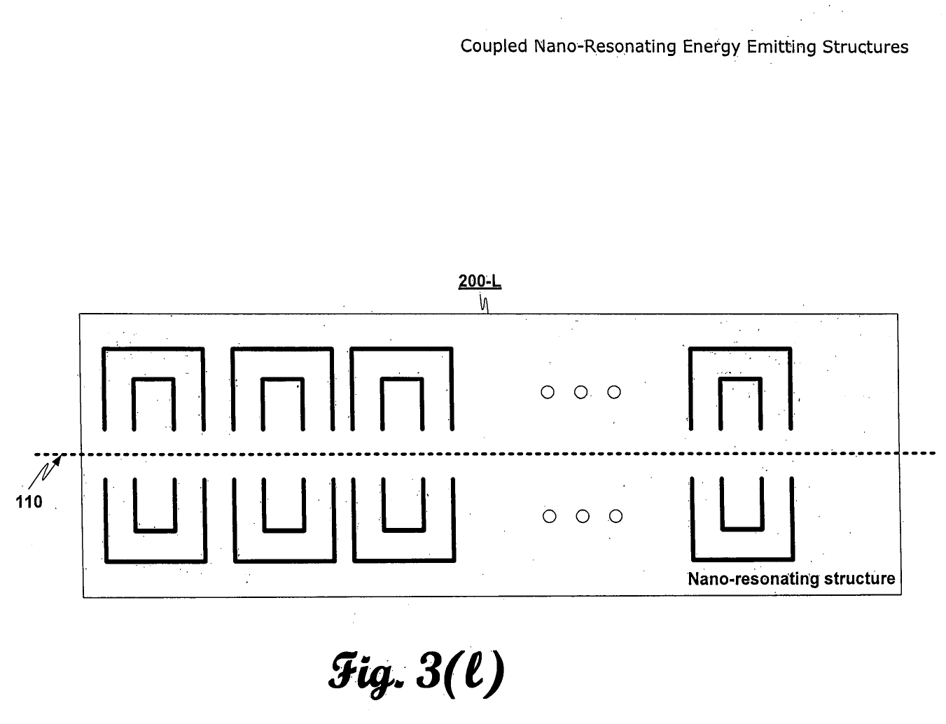

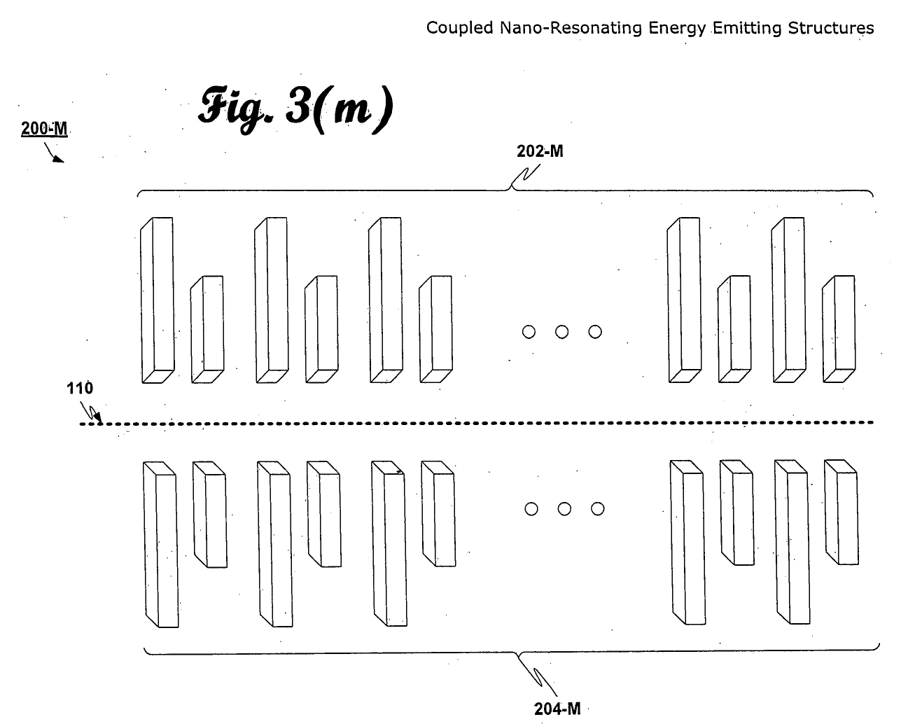

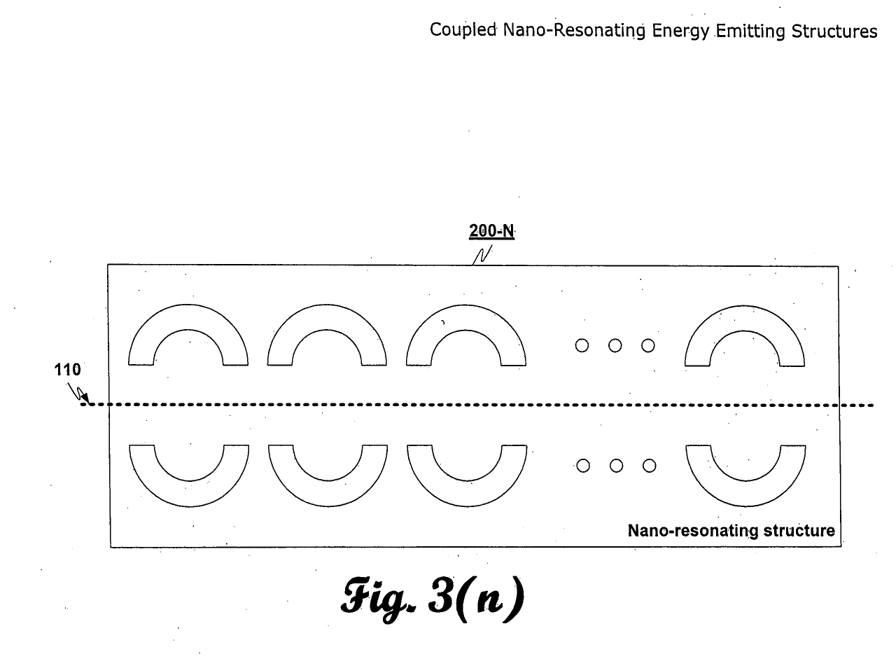

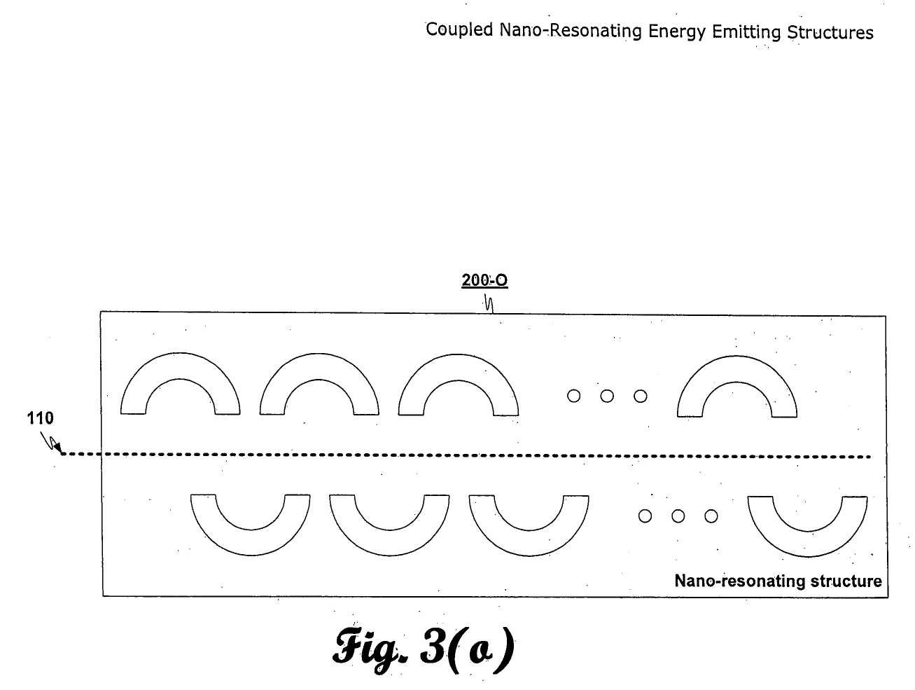

In some cases it may be difficult to position the waveguide conduit 212 in an optimal or even suitable location. For example, depending on the structure 202, the angle of the emitted light relative to the surface of the substrate 204 and/or the angle of the conical region may make positioning of the waveguide conduit difficult or even impossible. In such cases, additional reflective structure be provided, e.g., on the substrate, in order to direct the emitted light to the waveguide. In addition to reflecting the emitted light, the reflective structure may be used to narrow or widen the beam. For example, as shown in FIG. 3, a reflective structure 216 is positioned on the surface of the substrate 204 to redirect the emitted light E (the redirected light is denoted Er) to the waveguide conduit. Note that the conical volume 218 may have a wider or narrower angle than that of the light emitted from the structure 202. Reflective structure 216 may comprise on or more reflective elements formed on the substrate 204 and/or in a package containing the substrate.

Those skilled in the art will immediately understand that more than one reflective structure 216 may be provided. Further, more than one nano-resonant structure 202 may emit light into the same reflective structure. In this manner, a single waveguide conduit may be provided for multiple nano-resonant structures.

It is preferable to position the waveguide conduit 212 to capture as much of the emitted light as possible.

In some embodiments, the nano-resonating structure 202 and the waveguide conduit 212 may be integrated into a single microchip.

Communication Between Multi-Chip Modules

The resonant structures described herein can be used as part of an optical interconnect system that allows various integrated circuits to communicate with each other.

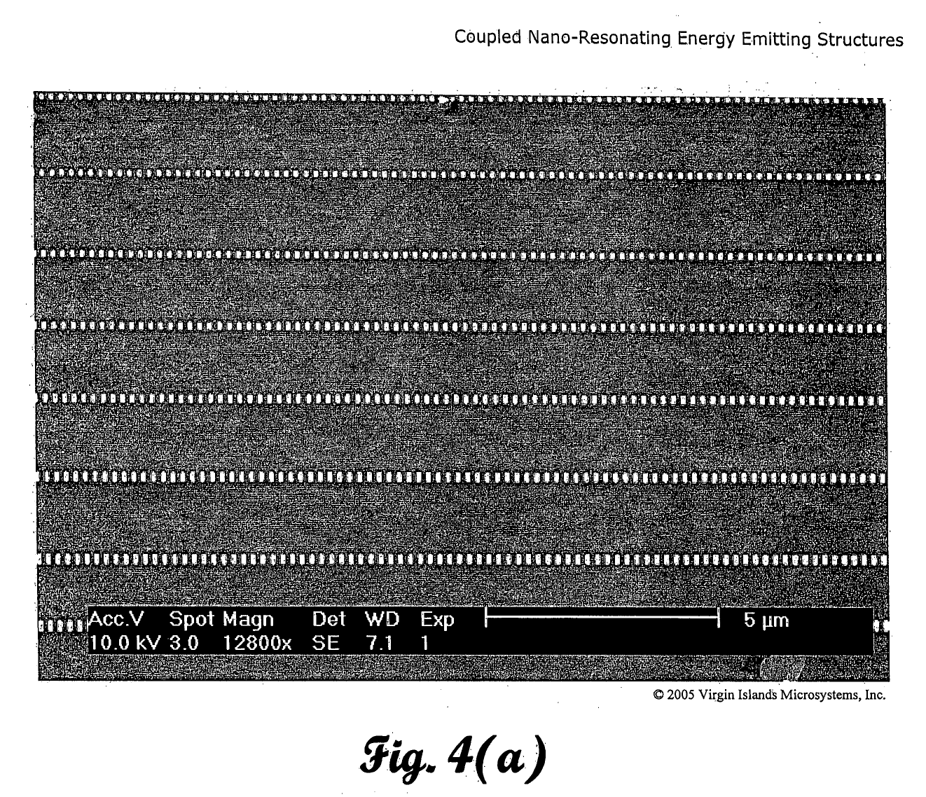

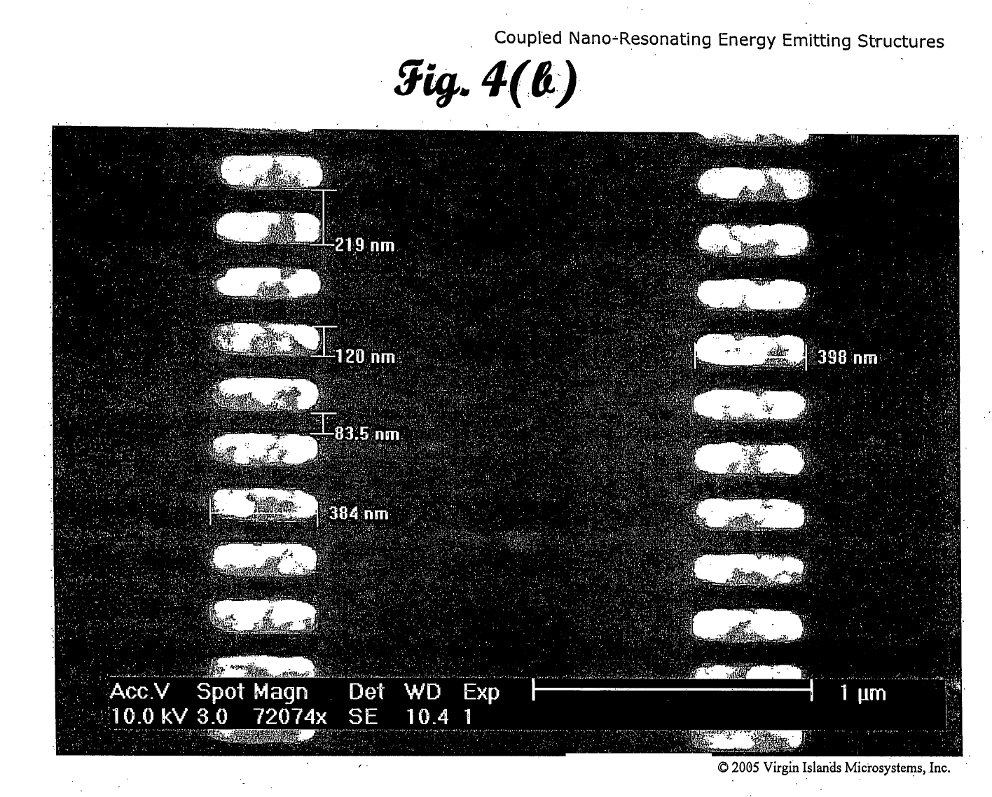

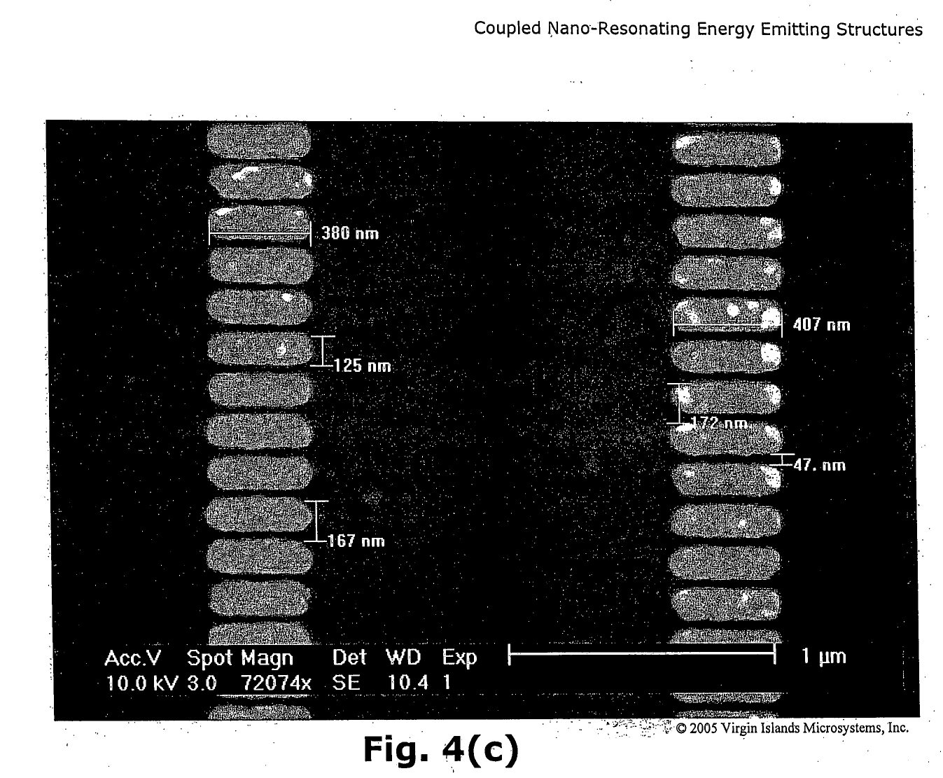

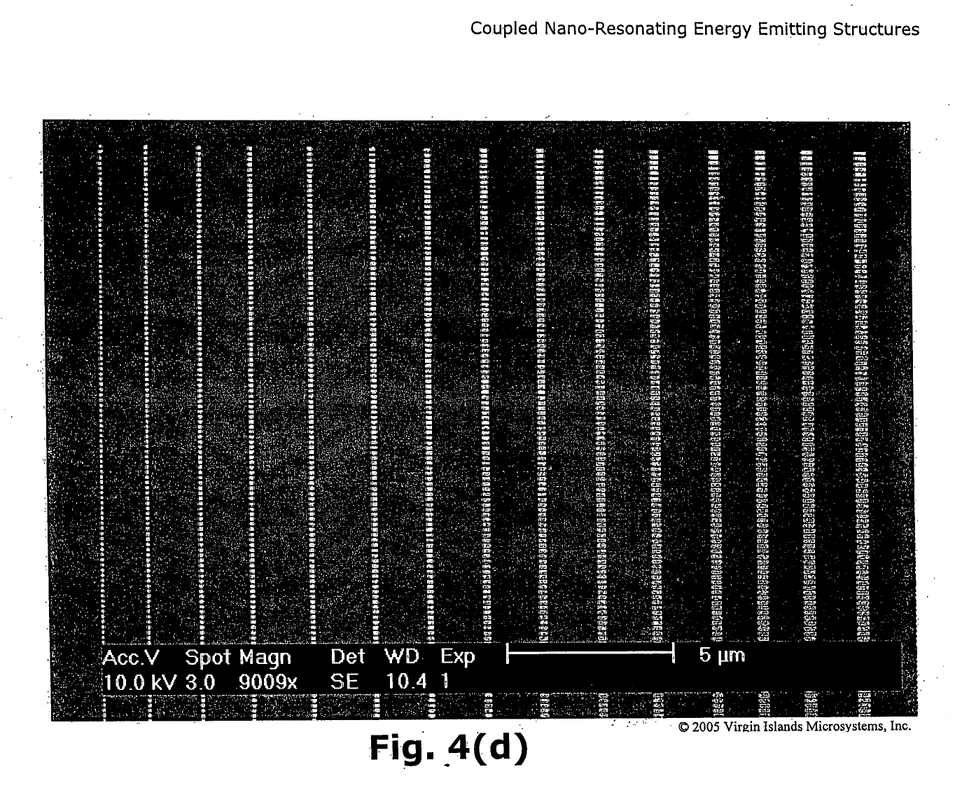

With reference to FIG. 4, a multi-chip module 220 consists of a number of interconnected chips or integrated circuits (ICs). (The terms “chip” and “IC” are used synonymously herein.) By way of example, in the drawing, three chips 222-1, 222-2, 222-3 (collectively chips 222) are shown. Those skilled in the art will realize that a multi-chip module may contain two or more chips. In the example shown, chip 222-1 is optically connected to chip 222-2 by connector 224-1 and to chip 222-3 by connector 224-2. Chip 222-2 is optically connected to chip 222-3 by connector 224-3. In some embodiments, the connectors 224-1, 224-2, 224-3 (collectively 224), may be fiber optic cables or wires. In the drawing each chip is shown connected to each other chip. The actual interconnections between any chips in a multi-chip module will depend on the requirements and functionality of the module and its component chips. Further, some or all of the chips 222 may be connected to each other in other manners, e.g., electrically, as well as or instead of optically.

For the purposes of explanation, the circuitry of a chip may logically be divided into functional circuitry (generally 226)—i.e., the part circuitry that performs the function of that particular chip—and optical communications circuitry (generally 228)—i.e., the part of the circuitry that performs the optical communication. In implementation, the functional circuitry may overlap with the communications circuitry. By way of example, in FIG. 4, the chip 222-1 is shown to contain functional circuitry 226-1 and optical communications circuitry 228-1. Similarly, the chip 222-2 is shown to contain functional circuitry 226-2 and optical communications circuitry 228-2.

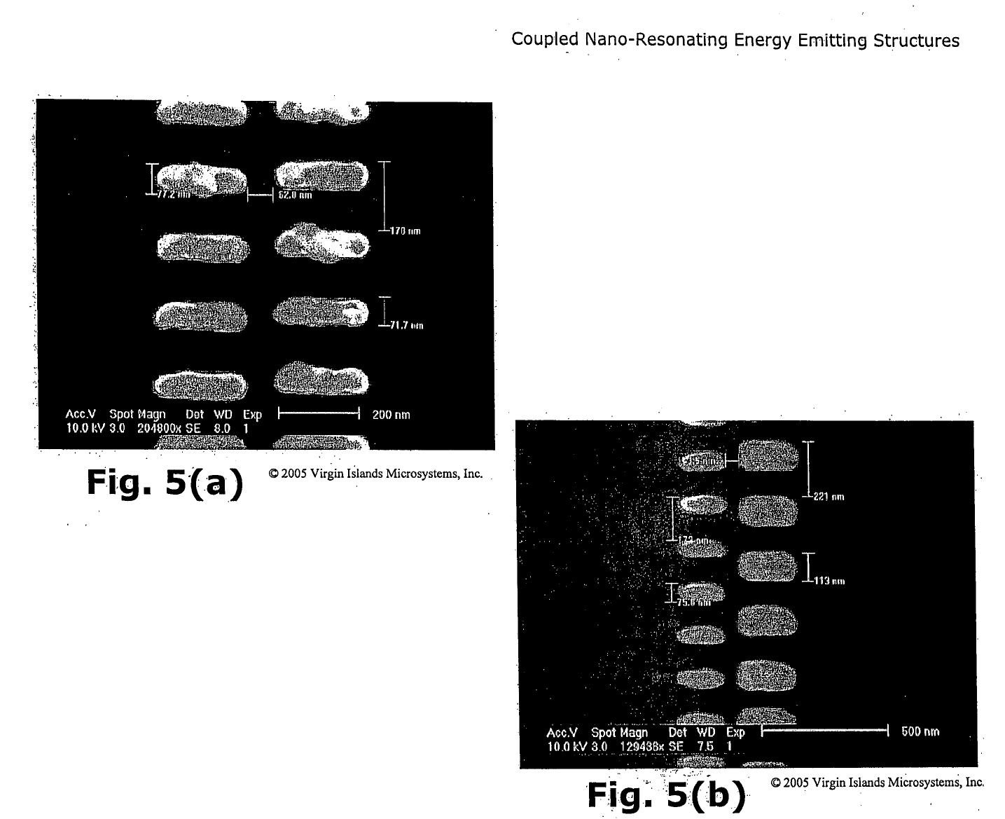

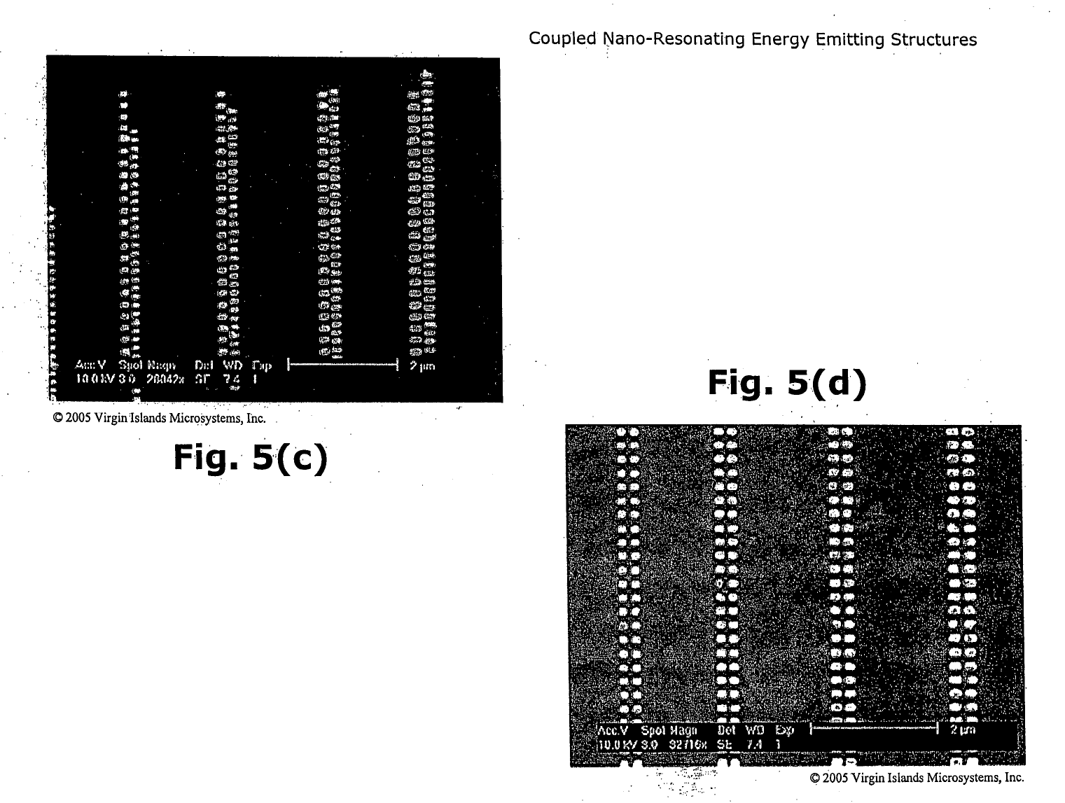

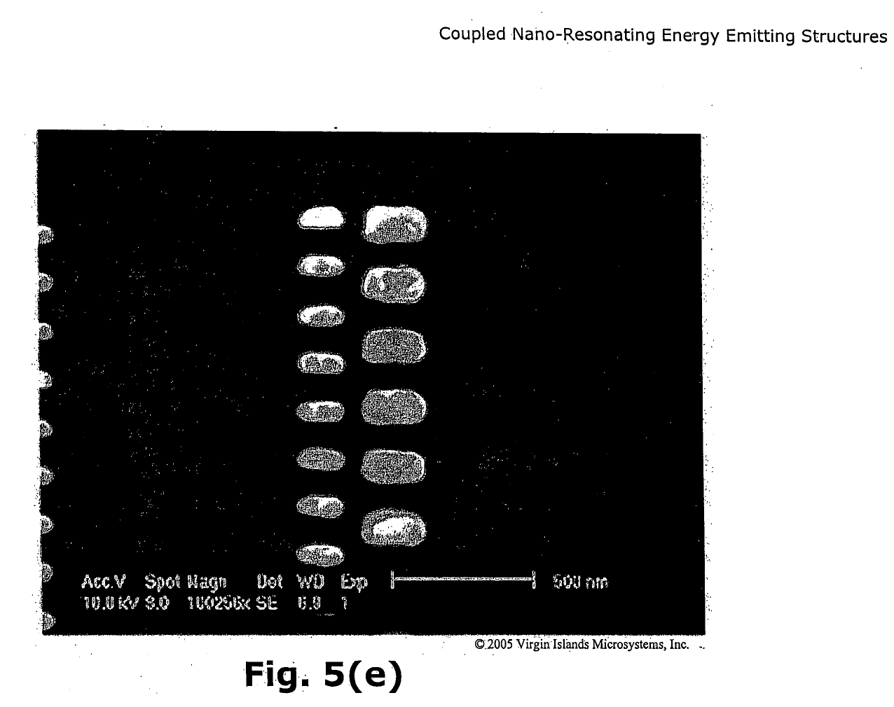

As shown in FIG. 5, the optical communications circuitry 228 consists of an optical transmitter 230 and an optical receiver 232, each operationally and functionally connected to the functional circuitry 226, so that data from the chip 222 can be sent via optical transmitter 230, and data coming in to the chip 222 can be received by the optical receiver 232. It will be understood by those of skill in the art that a particular IC may not have or require both receiver circuitry and transmitter circuitry.

The optical transmitter 230 may be formed by one or more nano-resonant structures 202, e.g., as shown in FIGS. 1-3. Although not shown in detail in the drawings, the emitter electromagnetic wave E may by connected to the functional circuitry 226 to drive the wavelength and/or frequency and/or other properties of the emitted radiation to provide a data stream.

The optical receiver 232 may be, e.g., a device as described in related U.S. application Ser. No. 11/400,280 which is incorporated herein by reference (and attached hereto as appendix 13). Other devices may also be used. Output from the optical receiver 232 is provided to the functional circuitry 226.

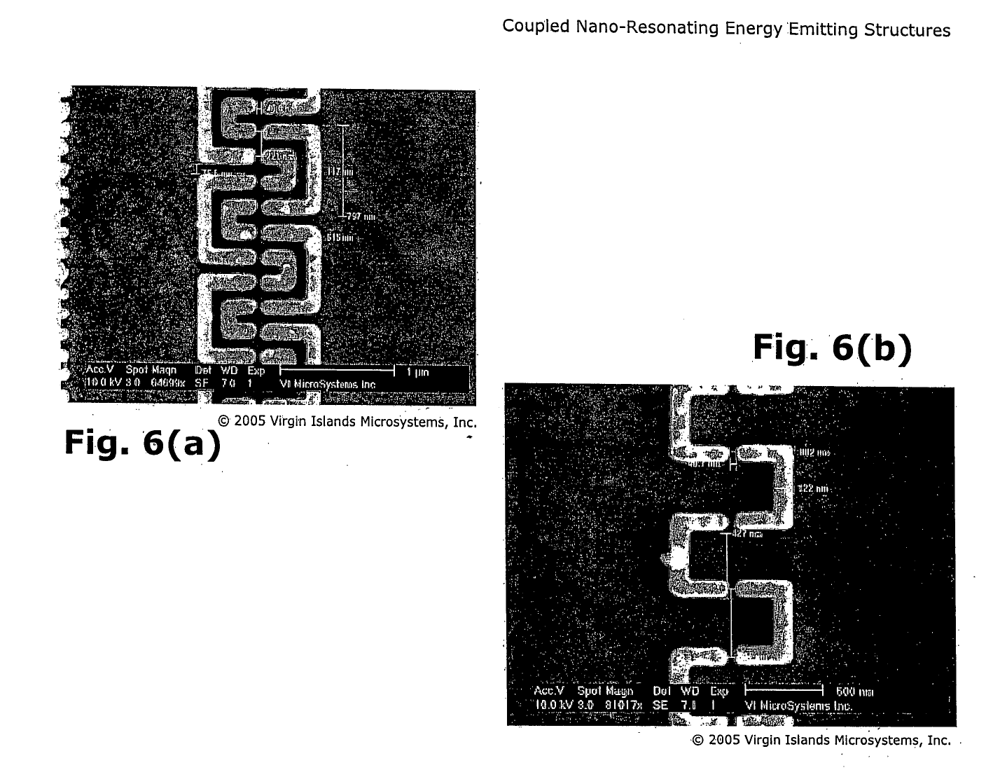

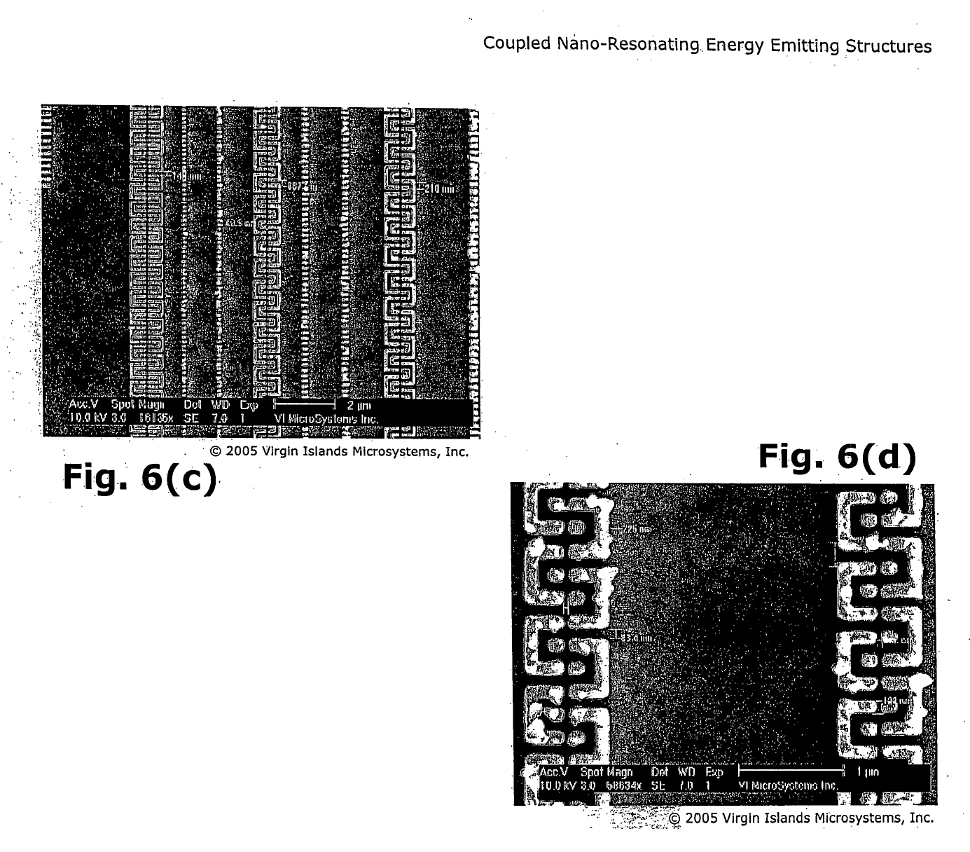

In the exemplary embodiment illustrated in FIG. 6, substrates 240 and 242 have mounted thereon various integrated circuits (“ICs”) 244, 246, 248 which each include respective optical communications sections 250, 252, 254. Each optical communications section includes at least one transmitter and/or at least one receiver. Such transmitters may include at least one resonant structure as described herein. Such receivers may include a receiver for receiving optical emissions from at least one resonant structure as described herein. The optical communications section of the IC corresponds to the optical communications circuitry 228 shown in FIGS. 4-5.

Substrates 240, 242 optionally may include, mounted thereon or mounted in between, one or more optical directing elements 256 such as, e.g., a mirror, a lens, or a prism. As shown in FIG. 6, an optical emission from the optical communications section 252 of an integrated circuit 246 can be transmitted directly to an optical communications section 254 of an IC 248 on an opposite substrate 240. Alternatively, an optical emission from the optical communications section 250 of an IC 242 can be reflected off or otherwise directed by an optical directing element 256 to an optical communications section 252 on the same substrate 242 or on a different (e.g., opposite) substrate 240. In some cases (not shown in the drawings), more than one optical directing element may be used to direct a beam from one IC to another.

Each of the optical communications sections 250, 252, 254 can transmit on the same frequency or can transmit on one of plural frequencies. For example, all optical communications sections 250, 252, 254 could transmit at the same frequency (e.g., an infrared, visible or ultraviolet frequency), but such a configuration may cause “collisions” (as that term is used in Ethernet-style communications) between any two integrated circuits transmitting at the same time. Those of ordinary skill in the art would understand that collision-detection and “back-off” can be used to determine a time at which to retransmit the message after a collision.

Instead of using a single frequency for all communications, each integrated circuit could be assigned its own, unique receiver frequency. In such a configuration, collisions would only occur when transmitters attempted to transmit to the same integrated circuit at the same time. This would require, however, that each integrated circuit be equipped with as many transmitters as there are receiver frequencies. This is straightforward to accomplish by using a multi-wavelength emitter such as, e.g., as disclosed with reference to FIGS. 6a-6c of U.S. application Ser. No. 11/410,924, and other similar structures.

A backplane may also be segmented into plural parts, e.g., using filters 258, 260. Filters 258, 260 allow certain frequencies to remain confined within a particular segment of the backplane. For example, filters 258, 260 can filter light of a first frequency such that it does not pass further along the backplane. However, the filters 258, 260 can allow light of a second frequency to pass through them. This structure would allow some communications (e.g., at the first frequency) to be local-only communications while other communications (e.g., at the second frequency) to be global communications with integrated circuits 258, 260 outside of a segment.

Such a communications structure is preferable in some configurations where the same cell or processor is repeated as part of a parallel processing system, but where each cell or processor still needs to communicate globally. One such a configuration can be used between a first set of circuits (e.g., on a first substrate) acting as distributed, parallel processors, and a second set of circuits (e.g., on a second substrate) acting as local and global memories. In such a case, the local memories and their corresponding processors would be separated from each other by optical filters. Thus, each processor could transmit to its corresponding memory on the same frequency without interfering with neighboring processors because of the filters. However, each processor could still communicate with the global memory using a second frequency which is not blocked by the filter. The second frequency of each processor can be the same for all processors or can be processor-specific.

Preferably, when multiple frequencies are used, the characteristics of the resonant structures are selected such that emissions by a resonant structure of non-predominant frequencies is kept sufficiently low on frequencies which are a predominant frequency for another resonant structure that correct message transmission and receipt is achieved.

Those skilled in the art will realize that the optical communication circuitry of a particular chip may have more than one optical transmitter and/or optical receiver. For example, for the multi-chip module shown in FIG. 4, each chip is connected to each other chip and so each chip may have two optical transmitters and two optical receivers.

As shown in FIGS. 1-3, an optical waveguide such as an optical fiber can be used to connect the optical transmitter of one chip to the optical receiver of another chip. The example shown in FIG. 4 used, for the purposes of explanation, a three-chip multi-chip module. As the number of chips in the multi-chip module increases, so too does the possible number of required interconnections.

Wavelength Connector

In order to simplify and/or reduce the interconnect requirements and increase practical speed of communication, an optical connector may be provided. FIG. 7 shows a multi-chip module in which some or all of the integrated circuits (ICs) interconnect via an optical connector 240. The optical connector 240 may consist of circuitry constructed and adapted to provide the light output from each IC as the input to each other IC optically connected thereto.

In one embodiment, each IC is assigned an input wavelength, denoted λ_{IC}. The input wavelength for an IC is the wavelength of the light it will accept as input. Light of wavelengths other than the input wavelength can be ignored by the IC. The optical communication circuitry 228 in the IC may be adapted to ignore wavelengths other than the input wavelength. In some embodiments, some ICs may accept inputs at two or more input wavelengths.

The optical transmitter in each chip can be configured to produce output at a number wavelengths and/or frequencies. In this manner, each IC can provide data to each other chip by sending that data at the wavelength and/or frequency of the target chip. Essentially an input wavelength of an IC becomes an address for that IC. Note that more than one IC can accept input at the same wavelength. In addition, as noted earlier, an IC may accept inputs on more than one wavelength. The wavelength connector 240 can pass the output from each IC as an input to each other IC. The target IC(s) will effectively self-select the input by accepting inputs of their respective wavelength(s).

As used herein, unless otherwise specifically stated, the term “optically connected,” when referring to two components, means that there is some path, direct or indirect, between the components along which EMR can travel, so that EMR from one of the components can reach the other of the components. It will be understood that optically connected devices or chips or components need not be directly connected via fibers or the like. It will be further understood that an optical connection may include one or more optical reflectors, redirectors or the like, one or more optical boosters or attenuators or the like.

Various light-emitting resonator structures have been disclosed, e.g., in the related applications listed above. The word “light” refers generally to any electromagnetic radiation (EMR) at a wide range of frequencies, regardless of whether it is visible to the human eye, including, e.g., infrared light, visible light or ultraviolet light. It is desirable to couple such produced light into a waveguide, thereby allowing the light to be directed along a specific path.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A multi-chip module comprising:
a plurality of chips, at least some of said chips including at least one nano resonating structure; and
an optical connector including a nano resonating structure,
wherein at least some of the chips are optically interconnected to each other via the optical connector, and wherein at least some of the chips optically connected to the connector each have at least one input wavelength associated therewith, and wherein data may be provided to one or more chips connected to the connector by providing the data via the connector at one or more wavelengths associated with the one or more chips.

2. A multi-chip module as in claim 1, wherein at least some of said chips comprise:
optical communication circuitry constructed and adapted to transmit data at one or more wavelengths

3. A multi-chip module as in claim 1 wherein at least some of said chips comprise:
optical communication circuitry constructed and adapted to receive input data at one or more input wavelengths.

4. A multi-chip module as in claim 2 wherein said optical communication circuitry is further constructed and adapted to receive input data at one or more input wavelengths.

5. A multi-chip module as in claim 1 wherein data are provided from a first chip optically connected to the optical connector to at least one other chip optically connected to the optical connector by optically transmitting the data from the first chip at one of the input wavelengths of the at least one other chip.

6. A multi-chip module as in claim 2 wherein at least some of the chips comprise:
at least one nano-resonant structure constructed and adapted to emit electromagnetic radiation (EMR) in response to excitation by a beam of charged particles.

7. A multi-chip module as in claim 6 wherein at least some of the chips comprise:
a source of charged particles.

8. A multi-chip module as in claim 7 wherein each said source of charged particles is selected from the group comprising:
an ion gun, a tungsten filament, a cathode, a planar vacuum triode, an electron-impact ionizer, a laser ionizer, a chemical ionizer, a thermal ionizer, and an ion-impact ionizer.

9. A multi-chip module as in claim 6 wherein the charged particles are selected from the group comprising: positive ions, negative ions, electrons, and protons.

10. A multi-chip module as in claim 6 wherein the at least on nano-resonant structure is constructed and adapted to emit at least one of visible light, infrared light, and ultraviolet light.

11. A multi-chip module as in claim 6 further comprising:
at least one reflective element constructed and adapted to direct EMR emitted by the at least one nano-resonant structure.

12. A system comprising:
a plurality of integrated chips; and
an optical connector,
wherein at least some of the chips are optically interconnected via the wavelength multiplexed connector, and
wherein at least some of the chips comprise:
at least one nano-resonant structure constructed and adapted to emit electromagnetic radiation (EMR) in response to excitation by a beam of charged particles.

13.-18. (canceled)

19. A method comprising:
providing a plurality of chips in a multi-chip module, at least some of said chips including at least one nano resonating structure;
providing an optical connector;
optically interconnecting at least some of said chips via said optical connector;
associating at least one input wavelength with at least one of said nano resonating structures;
transmitting data to a particular chip by sending the data to that chip via the optical connector at an input wavelength associated with a nano resonating structure on that chip.

20. A method as in claim 19 further comprising, at least one of said chips:
providing a source of charged particles;
providing at least one nano-resonant structure constructed and adapted to emit electromagnetic radiation (EMR) in response to excitation by the beam of charged particles.

21. A method as in claim 20 wherein the source of charged particles is selected from the group comprising:
an ion gun, a tungsten filament, a cathode, a planar vacuum triode, an electron-impact ionizer, a laser ionizer, a chemical ionizer, a thermal ionizer, and an ion-impact ionizer.

22. A method as in claim 20 wherein the charged particles are selected from the group comprising: positive ions, negative ions, electrons, and protons.

23. A method as in claim 20 wherein the EMR comprises one or more of: visible light; infrared light; and ultraviolet light.

24. A method comprising:
providing a plurality of chips in a multi-chip module, first and second ones of said chips including corresponding first and second nano resonating structures;
associating a first input wavelength with the first of said nano resonating structures;
associating a second input wavelength different from the first input wavelength with the second nano resonating structure;
sending data from a chip of said plurality of chips to the first of said plurality of chips, via an optical connector, by sending the data at the first input wavelength; and
sending data from a chip of said plurality of chips to the second of said plurality of chips, via the optical connector, by sending the data at the second input wavelength.
